(19) United States
(12) Patent Application Publication
(10) Pub. No.: US 2010/0248113 A1
(43) Pub. Date: Sep. 30, 2010

(54) CARRIER COATED WITH RESIN FOR ELECTROPHOTOGRAPHIC DEVELOPER AND ELECTROPHOTOGRAPHIC DEVELOPER USING THE CARRIER COATED WITH RESIN

(75) Inventors: Tetsuya UEMURA, Kashiwa-shi (JP); Tomoaki KOBAYASHI, Kashiwa-shi (JP); Naoto KURAMOCHI, Kashiwa-shi (JP); Tadashi TSUDUKI, Kashiwa-shi (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/721,600

(22) Filed: Mar. 11, 2010

(30) Foreign Application Priority Data
Mar. 30, 2009 (JP) 2009-083268

(51) Int. Cl. G03G 9/113

(52) U.S. Cl. 430/105

(57) ABSTRACT

A carrier coated with a resin for an electrophotographic developer in which a carrier particle surface is coated with the resin and the coating resin contains a lithium salt, and an electrophotographic developer using the carrier coated with the resin.

### TECHNICAL FIELD

The present invention relates to a carrier coated with a resin for an electrophotographic developer used in a two-component electrophotographic developer for use in copying machines, printers, etc. and an electrophotographic developer using the carrier coated with a resin.

### BACKGROUND ART

To improve durability of a carrier for a two-component developer, carriers coated with a resin for preventing spent toner have been reported.

However, the resistivity of a carrier increased by coating the carrier with a resin. As a result, image density decreases and edge effect occurs. Such deterioration of image quality becomes a problem. The value of resistance of the carrier must be optimized by controlling a machine system and development conditions. As a method for controlling the carrier resistivity, addition of a conductive substance (conductant agent) to a coating resin layer is reported in many documents. As a general conductive substance, various types of carbon black are widely known since they are easy to control resistivity at low cost.

When a carrier whose resistivity is controlled by adding carbon black to a coating resin is used in combination with a color toner, particularly, a light-color toner (such as yellow), no problems occur in terms of image density and edge effect; however, toner is contaminated with carbon black added to the coating resin, leading to a murky colored toner. Such quality degradation is a matter of concern. In addition, the carrier using carbon black has a problem in environment dependency. Since the resistivity of carbon black is extremely low, dependency on resistivity increases. Particularly under a high-temperature and high-humidity environment, leakage of charge occurs. At the start-up time when a machine is turned on, significant discharge occurs and ground staining tends to occur. In addition, since a charge-raising rate is low, a clear image cannot be obtained. Such a toner has a problem in environment dependency.

To deal with such color staining (ground staining) and environment dependency, the following proposals have been made. Japanese Patent Application Laid-Open No. 8-286429 proposes a two-layer coated carrier. The coating layer herein contains two layers. To the inner coating layer, conductive carbon is added and a white conductive agent is added to an external coating layer formed on the inner coating layer. Furthermore, Japanese Patent Application Laid-Open No. 2000-221733 proposes a carrier for an electrostatic latent image developer. The carrier contains a conductive powder in a coating resin layer in an amount of 25 to 45% by volume. The conductive powder contains a needle-form conductive powder in a mixing ratio within the range of 20 to 100% by volume. The electric resistivity of the coating resin layer falls within the range of 1×10 to 1×10⁸Ω·cm. Furthermore, Japanese Patent No. 3904174 proposes a carrier for an electrophotographic developer prepared by coating the surface of the carrier with an insulating resin containing a white conductive agent. The white conductive agent herein is formed of at least two types of powders of TiO₂, ZnO₂ or SnO₂ different in average particles size and having spherical to massive form. The powder is characterized by having a SnO₂ conductive layer, which has a solid solution of a fifth-group metal in the surface and a thickness of 5 to 50 angstroms.

Furthermore, Japanese Patent Application Laid-Open No. 2004-354631 proposes a carrier for an electrophotographic developer, in which the surface of a core material is coated with a resin layer containing a phthalocyanine compound serving as a conductive agent. Japanese Patent Application Laid-Open No. 2005-241769 proposes a carrier for a color developer, characterized by coating the surface of a core material with a resin layer containing a polyalkylene oxide represented by a specific chemical formula and serving as a conductive agent. Furthermore, Japanese Patent Application Laid-Open No. 2007-57659 proposes an electrophotographic carrier having a coating resin layer containing a conductive material on the surface of a core material. At least the outermost surface of the coating resin layer is formed of a crosslinkable resin and the content of the conductive material is reduced toward the surface.

Japanese Patent Application Laid-Open No. 2007-240615 proposes an electrophotographic carrier, in which a binder resin layer contains white conductive particles having a conductive coating layer formed of tin dioxide and indium oxide formed on base particles. Japanese Patent Application Laid-Open No. 2007-248614 proposes an electrophotographic carrier, which is a carrier having a resin coating layer on a core-material surface and the resin coating layer contains a tin oxide containing antimony. The tin oxide containing antimony contains antimony in an amount of not less than 0.0005% by mass and not more than 1.0% by mass relative to the total electrophotographic carrier. Japanese Patent Application Laid-Open No. 2008-268583 proposes an electrophotographic carrier characterized in that a core-material surface is coated with a layer containing a binder resin, an ionic liquid and an inorganic microparticle.

However, the proposals of these Patent Documents using carbon black actually provide no fundamental solutions to the aforementioned problems, since color staining occurs when a coating layer peels during a long-time toner life test. Furthermore, in a carrier coated with a resin containing an inorganic oxide, since the inorganic oxide itself has high resistivity, the amount of inorganic oxide to be added to the resin must be drastically increased compared to that of carbon black in order to obtain a desired resistivity value, with the result that durability of the coating resin decreases.

Furthermore, as described in Japanese Patent Application Laid-Open No. 2008-268583, in the carrier coated with a layer containing an ionic liquid, leakage of charge occurs by the ionic liquid, decreasing the amount of charge.

Recently, with a demand for forming high-quality image, the size of toner particles tends to decrease. Therefore, studies have been conducted in a high charge amount area. Furthermore, with a demand for forming high-quality image and long product life, the core material for a carrier has been changed from a core material having high magnetic force such as iron powder to a core material having low magnetic force such as ferrite. As a result, the resistivity of the core material increases. In this circumstance, if a developer is prepared by a conventional method, the resistivity of the developer becomes excessively large and image density decreases. In addition, edge effect occurs and thus desired image quality and product life cannot be obtained. This is a matter of concern. If the addition amount of the conductive substance increases to control the resistivity, the strength of the coating resin decreases and the product life further decreases.

As described above, a carrier causing no significant color staining even if used in combination with a color toner, particularly, yellow toner, being free of image-quality deterioration, more specifically, an image-density decrease and edge effect caused when the resistivity of the carrier increases, and having less environment dependency and excellent durability causing no charge-amount decrease with the passage of time has not yet been obtained.

### DISCLOSURE OF THE INVENTION

### Problem to be Solved by the Invention

Accordingly, an object of the invention is to provide a carrier coated with a resin for an electrophotographic developer causing no significant color staining even if used as a developer in combination with a toner, in particular, a color toner, being free of image-quality deterioration, more specifically, an image-density decrease and edge effect caused when the resistivity of the carrier increases, and having less environment dependency and excellent durability causing no charge-amount decrease with the passage of time, and to provide a developer using the carrier coated with a resin.

### Means for Solving the Problem

The present inventors found that the above object of the present invention can be attained by adding a lithium salt to a coating resin of a resin-coated carrier prepared by coating the surface of carrier particles (carrier core-material) with a resin, and reached the present invention.

More specifically, the present invention provides a carrier coated with a resin for an electrophotographic developer, in which a carrier particle surface is coated with the resin and the coating resin contains a lithium salt.

In the carrier coated with a resin for an electrophotographic developer according to the present invention, the lithium salt is an ionic conductive polymer and the addition amount of the lithium salt relative to the solid content of the coating resin is desirably 0.2 to 35.0 wt %.

In the carrier coated with a resin for an electrophotographic developer according to the present invention, the lithium salt desirably has a fluorine group.

Furthermore, the present invention is provides an electrophotographic developer comprising the carrier coated with a resin and a toner.

An electrophotographic developer according to the present invention is used also as a replenishing developer.

### EFFECT OF THE INVENTION

The carrier coated with a resin for an electrophotographic developer according to the present invention and the electrophotographic developer using the carrier cause no significant color staining even if used in combination with a toner, particularly, a color toner. Furthermore, the carrier is free of image-quality deterioration, more specifically, an image-density decrease and edge effect caused when the resistivity of the carrier increases. Furthermore, the carrier has less environment dependency and excellent durability causing no charge-amount decrease with the passage of time.

### MODE FOR CARRYING OUT OF THE INVENTION

Mode for carrying out the invention will be described below. In the carrier coated with a resin for an electrophotographic developer according to the present invention, the surface of the carrier particles is coated with a resin.

As the carrier particles (carrier core-material) used herein, a core material conventionally used as a core material for a carrier for an electrophotographic developer, such as an iron powder core material, a magnetite core material, a resin carrier core-material or a ferrite core material is mentioned. Of them, a ferrite core material containing at least one element selected from Mn, Mg, Li, Ca, Sr and Ti is particularly desirable. In consideration of recent tendency toward reducing environmental burden including waste regulation, it is preferred that heavy metals such as Cu, Zn and Ni are not contained beyond the inevitable-impurity (concomitant impurity) range.

Furthermore, when the carrier core material is formed of a ferrite core material comprising ferrite particles, high-porosity ferrite particles can be also used. In this case, voids of the ferrite particles may be filled with a resin. Such a ferrite carrier filled with a resin can be used as a carrier core material.

Furthermore, the average particle size (D₅₀) of the carrier core material is desirably 15 to 80 μm. If D₅₀ falls within this range, carry over of carrier beads is prevented and good quality of an image can be obtained. An average particle size of less than 15 μm is not preferable because carry over of carrier beads is likely to occur. Furthermore, an average particle size exceeding 80 μm is not preferable because image quality is likely to deteriorate.

### (Average Particle Size)

The average particle size is obtained by measuring the size of particles by a micro-track particle size analyzer (Model 9320-X100) manufactured by Nikkiso Co., Ltd., using water as a dispersant medium. A sample (10 g) and water (80 ml) are placed in a 100-ml beaker and a few liquid drops of a dispersant (sodium hexametaphosphate) are added. Subsequently, the mixture is dispersed for 20 seconds by use of an ultrasonic homogenizer (Type UH-150, manufactured by SMT. CO. LTD.) at an output level of 4. Thereafter, foams are removed from the surface of the dispersant medium and the sample is loaded to the apparatus (analyzer).

The coating resin to be used in a carrier coated with a resin for an electrophotographic developer according to the present invention is not particularly limited. A straight silicone resin, an acrylic resin, a polyester resin, an epoxy resin, a polyamide resin, a polyamide-imide resin, an alkyd resin, a urethane resin and a fluorine resin, etc. are mentioned. These may be used in combination with two or more types. Furthermore, a modified resin such as a modified silicone resin may be used.

The coating amount of coating resin is desirably 0.1 to 3.5 wt % relative to the carrier core-material. If the coating amount of resin is less than 0.1 wt %, the state of spent toner deteriorates and the amount of charge after a duration test (toner life test) decreases. If the coating amount exceeds 3.5 wt %, particles aggregate and the state of spent toner deteriorates.

A carrier coated with a resin for an electrophotographic developer according to the present invention contains a lithium salt in the coating resin.

Examples of the lithium salt may include those represented by the following structural formulas: (C₂F₅)₂POLi, CF₃CO₂Li, (CF₃CO)₂NLi, CF₃SO₃Li, CH₃SO₃Li, C₆F₅SO₃Li, C₆H₅SO₃Li, C₈F₁₇SO₃Li, (CF₃SO₂)₂NLi, (C₂F₅SO₂)₂NLi, (FSO₂C₆F₄)(CF₃SO₂)NLi, (C₈F₁₇SO₂)(CF₃SO₂)NLi, (CF₃CF₂CH₂OSO₂)₂NLi, (HCF₂CF₂CH₂OSO₂)₂NLi, ((CF₃)₂CHOSO₂)₂NLi, (CF₃SO₂)₃CLi, (CF₃CH₂OSO₂)₃CLi, LiClO₄ and Li[B(C₁₄H₁₀O₃)₂]. It is not preferred that the coating resin contains conductive materials except a lithium salt. This is because a desired resistivity value cannot be obtained, or alternatively, color staining occurs and the amount of charge decreases.

The lithium salt is an ionic conductive polymer. The content thereof relative to the solid content of the coating resin is desirably 0.2 to 35.0 wt %, and further desirably 0.5 to 30.0 wt %. The ionic conductive polymer herein refers to a polymer compound having high ion conductivity. When the content of a lithium salt is less than 0.2 wt %, the lithium salt contained cannot produce an effect and a desired resistivity cannot be obtained. When the content of a lithium salt exceeds 35.0 wt %, leakage of charge occurs and the amount of charge decreases.

Of these lithium salts used in the present invention, particularly, a lithium salt having a fluorine group is preferable. If the lithium salt having a fluorine group is used, the resistivity value can be easily controlled to a desired value and the amount of charge can be suppressed from decreasing.

In the present invention, other types of conductive agents (conductive materials) can be contained in combination with the lithium salt in the coating resin in order to control electric resistivity, charge amount and charging speed of the carrier. Since the conductive agent itself has a low electric resistivity, if the content thereof is excessively large, rapid leakage of charge occurs. The content of the other types of conductive agents is 0.25 to 20.0 wt % relative to the solid content of the coating resin, and preferably 0.5 to 15.0 wt %. Examples of the other types of conductive agents include conductive carbon, oxides such as titanium oxide and tin oxide, organic conductive agents and ionic liquids.

In the present invention, a charge controlling agent may be contained in the coating resin. Examples of the charge controlling agent include various types of charge controlling agents and silane coupling agents generally used for toner. This is because the charging ability, which may sometimes decrease when a large amount of resin is used, can be controlled by adding a charge controlling agent and a silane coupling agent. The types of charge controlling agent and coupling agent to be used are not particularly limited; however, a charge controlling agent such as nigrosine dye, a quaternary ammonium salt, an organic metal complex and a metal containing monoazo dye; and an aminosilane coupling agent and the like are preferable.

<Electrophotographic Developer According to the Present Invention>

Next, an electrophotographic developer according to the present invention will be described.

An electrophotographic developer according to the present invention comprises the aforementioned carrier for an electrophotographic developer and a toner.

As toner particles constituting the electrophotographic developer of the present invention, pulverized toner particles manufactured by a pulverizing method and polymer toner particles manufactured by a polymerization method are mentioned. In the present invention, toner particles obtained by either method can be used.

The pulverized toner particles can be obtained, for example, as follows. A binder resin, a charge controlling agent and a colorant are sufficiently mixed by a mixer such as Henschel mixer. The mixture is melt-kneaded by a twin screw extruder or the like, cooled, pulverized and classified. Thereafter, an external additive is added to the mixture and mixed by a mixer or the like to obtain the pulverized toner particles.

The binder resin constituting the pulverized toner particles is not particularly limited; however, polystyrene, chloropolystyrene, a styrene-chlorostyrene copolymer, a styrene-acrylate copolymer and a styrene-methacrylic acid copolymer are mentioned and further, a rosin modified maleic acid resin, an epoxy resin, a polyester resin and a polyurethane resin, etc. can be mentioned. These may be used alone or as a mixture.

As the charge controlling agent, any charge controlling agent can be used. For example, as the charge controlling agent for a positively charged toner, nigrosine dye and a quaternary ammonium salt, etc. can be mentioned. Furthermore, as the charge controlling agent for a negatively charged toner, a metal-containing monoazo dye and the like can be mentioned.

As the colorant (coloring material), dyes and pigments known in the art can be used. For example, carbon black, phthalocyanine blue, permanent red, chrome yellow, phthalocyanine green and the like can be used. Other than these, an external additive such as silica powder and titania can be added depending upon the toner particles in order to improve flowability and aggregation resistance of the toner particles.

Polymer toner particles are produced by a known method such as a suspension polymerization method, an emulsion polymerization method, an emulsion aggregation method, an ester elongation polymerization method and a phase inversion emulsification method. Such polymer toner particles can be obtained, for example, as follows. A colorant dispersion solution, in which a colorant is dispersed in water by use of a surfactant, is mixed with a polymerizable monomer, a surfactant and a polymerization initiator in an aqueous medium while stirring to emulsify and disperse the polymerizable monomer in the aqueous medium. After the monomer is polymerized while stirring and mixing, a salting agent is added to salt out polymer particles. The particles obtained by salting are filtrated, washed and dried to obtain the polymer toner particles. Thereafter, if necessary, an external additive is added to dried toner particles.

Furthermore, in manufacturing polymer toner particles, other than a polymerizable monomer, a surfactant, a polymerization initiator and a colorant, a fixability improving agent and a charge controlling agent can be blended. These agents contribute to controlling and improving properties of the resultant polymer toner particles. Furthermore, a chain transfer agent can be used for improving dispersibility of a polymerizable monomer in an aqueous medium and adjusting the molecular weight of the resultant polymer.

Although the polymerizable monomer to be used for manufacturing the polymer toner particles mentioned above is not particularly limited, for example, a styrene and a derivative thereof, an ethylene unsaturated mono-olefin such as ethylene and propylene, a vinyl halide such as vinyl chloride, a vinyl ester such as vinyl acetate, and an α-methylene aliphatic monocarboxylate such as methyl acrylate, ethyl acrylate, methyl methacrylate, ethyl methacrylate, 2-ethylhexyl methacrylate, dimethylamino acylate, and diethylamino methacrylate can be mentioned.

As the colorant (coloring material) to be used in preparing the polymer toner particles as mentioned above, dyes and pigments known in the art can be used. For example, carbon black, phthalocyanine blue, permanent red, chrome yellow and phthalocyanine green can be used. Furthermore, these colorants may be improved in surface by use of a silane coupling agent and a titanium coupling agent, etc.

As the surfactant to be used for manufacturing the polymer toner particles as mentioned above, an anionic surfactant, a cationic surfactant, an amphoteric surfactant and a nonionic surfactant can be used.

As the anionic surfactant used herein, an aliphatic acid salt such as sodium oleate and castor oil; an alkyl sulfate such as sodium lauryl sulfate and ammonium lauryl sulfate, an alkyl benzene sulfonate such as sodium dodecyl benzenesulfonate, an alkyl naphthalene sulfonate, an alkyl phosphate, a naphthalene sulfonate-formalin condensation product and a polyoxyethylene alkyl sulfate, etc. can be mentioned. Furthermore, as the nonionic surfactant, a polyoxyethylene alkyl ether, a polyoxyethylene fatty acid ester, a sorbitan fatty acid ester, a polyoxyethylene alkylamine, glycerin, a fatty acid ester and an oxyethylene-oxypropylene block polymer, etc. can be mentioned. Furthermore, as the cationic surfactant, an alkyl amine salt such as lauryl amine acetate and a quaternary ammonium salt such as lauryl trimethylammonium chloride and stearyl trimethylammonium chloride, etc. can be mentioned. Furthermore, as the amphoteric surfactant, an aminocarboxylic acid salt, an alkyl amino acid and the like can be mentioned.

A surfactant as mentioned above can be used generally in an amount within the range of 0.01 to 10 wt % relative to the polymerizable monomer. The use amount of surfactant affects dispersion stability of a monomer and dependency of the resultant polymer toner particles on the environment. For this reason, the surfactant is preferably used in an amount within the aforementioned range in which dispersion stability of a monomer can be ensured and the dependency of the resultant polymer toner particles on the environment is not excessively affected.

In manufacturing of polymer toner particles, a polymerization initiator is generally used. As the polymerization initiator, a water-soluble polymerization initiator and an oil-soluble polymerization initiator are mentioned. Either polymerization initiator can be used in the present invention. As the water soluble polymerization initiator that can be used in the present invention, for example, a persulfate salt such as potassium persulfate and ammonium persulfate and a water-soluble peroxide compound can be mentioned. Furthermore, as the oil-soluble polymerization initiator, for example, an azo compound such as azobisisobutyronitrile and an oil-soluble peroxide compound can be mentioned.

Furthermore, when a chain transfer agent is used in the present invention, as the chain transfer agent, for example, a mercaptan such as octyl mercaptan, dodecyl mercaptan and tert-dodecyl mercaptan, and carbon tetrabromide can be mentioned.

Furthermore, when the polymer toner particles to be used in the present invention contain a fixability improving agent, as the fixability improving agent, a natural wax such as carnauba wax and a wax of an olefin such as polypropylene and polyethylene, etc. can be used.

Furthermore, when the polymer toner particles to be used in the present invention contain a charge controlling agent, the charge controlling agent to be used herein is not particularly limited. Nigrosine dye, a quaternary ammonium salt, an organic metal complex and a metal containing monoazo dye, etc. can be used.

Furthermore, as the external additive to be used for improving e.g., the flowability of polymer toner particles, silica, titanium oxide, barium titanate, fluorine resin microparticles and acrylic resin microparticles, etc. can be mentioned. These can be used alone or in combination.

Furthermore, as the salting agent for separating the polymer toner particles from an aqueous medium, a metal salt such as magnesium sulfate, aluminum sulfate, barium chloride, magnesium chloride, calcium chloride and sodium chloride can be mentioned.

The average size of the toner particles manufactured as mentioned above falls within the range of 2 to 15 μm and preferably 3 to 10 μm. Polymer toner particles are more uniform in particle size than pulverized toner particles. When the average size of toner particles is less than 2 μm, chargeability decreases and photographic fog and toner scattering are likely to occur. When the average size of toner particles exceeds 15 μm, image quality deteriorates.

The carrier manufactured as mentioned above and a toner are mixed to obtain an electrophotographic developer. The mixing ratio of the carrier and the toner, that is, a toner concentration, is preferably set at 3 to 15 wt %. When the concentration is less than 3 wt %, a desired image density cannot be obtained. When the concentration exceeds 15 wt %, toner scattering and photographic fog are likely to occur.

An electrophotographic developer according to the present invention can be used also as a replenishing developer. At this time, the mixing ratio of the carrier and the toner, that is, a toner concentration, is preferably set at 100 to 3000 wt %.

An electrophotographic developer according to the present invention prepared as mentioned above can be used in a digital copying machine, printer, FAX and printing presses, etc. employing a developing system, in which a latent image formed on a latent image holder and having an organic optical conductive layer is developed, in a phase inversion manner, by a magnetic brush of a two component developer having a toner and a carrier while applying a bias electric field. Furthermore, the electrophotographic developer can be used in a full color machine using an alternating electric field, which is a method of superimposing AC bias on DC bias, when a developing bias is applied to a latent image by a magnetic brush.

The present invention will be more specifically described based on Examples, below.

### Example 1

Appropriate amounts of raw materials were dry-blended such that the raw materials were contained in an amount of 39.7 mol % in terms of MnO, 9.9 mol % in terms of MgO, 49.6 mol % in terms of Fe₂O₃ and 0.8 mol % in terms of SrO, respectively. The mixture was pulverized by a dry-process vibration mill for 2 hours and granulated by a dry-process granulator to obtain granulates having a size of about 2 cm. The granulates were calcined by a rotary kiln furnace at 950° C. to obtain a calcined product. The calcined product was again pulverized by a wet-process ball mill for 2 hours to obtain slurry, which was dried by a spray dryer to obtain granulates. The granulates were sintered in a tunnel kiln furnace under a nitrogen atmosphere at 1300° C. for 3 hours and crushed. Thereafter, the particle size distribution of the granulates was controlled to obtain an Mn—Mg—Sr ferrite core material having an average particle size of 60 μm.

Next, a methyl silicone resin (100 g on a solid basis) was weighed and dissolved in toluene (500 ml). To the mixture, further 10.0 wt % of a lithium salt ((CF₃SO₂)₂NLi) was added relative to the solid content of a methyl silicone resin to obtain a resin coating solution.

To the Mn—Mg—Sr ferrite core material (10 kg) obtained above, the resin coating solution obtained above was applied by a dip coating apparatus. Thereafter, the resultant particles were fired in a shelved drying chamber at 220° C. for 2 hours and crushed. Thereafter, the particle size distribution thereof was controlled to obtain a carrier coated with the resin.

### Example 2

A carrier coated with a resin was obtained in the same manner as in Example 1 except that the same Mn—Mg—Sr ferrite core-material and coating resin as in Example 1 were used and CF₃SO₃Li was used as a lithium salt.

### Example 3

A carrier coated with a resin was obtained in the same manner as in Example 1 except that the same Mn—Mg—Sr ferrite core-material and coating resin as in Example 1 were used and LiClO₄ was used as a lithium salt.

### Example 4

A carrier coated with a resin was obtained in the same manner as in Example 1 except that the same Mn—Mg—Sr ferrite core-material and coating resin as in Example 1 were used and Li[B(C₁₄H₁₀O₃)₂] was used as a lithium salt.

### Example 5

A carrier coated with a resin was obtained in the same manner as in Example 1 except that 0.5 wt % of a lithium salt (CF₃SO₂)₂NLi) was added relative to the solid content of the coating resin.

### Example 6

A carrier coated with a resin was obtained in the same manner as in Example 1 except that 30.0 wt % of a lithium salt (CF₃SO₂)₂NLi) was added relative to the solid content of the coating resin.

### Example 7

A carrier coated with a resin was obtained in the same manner as in Example 1 except that an acrylic resin was used as the coating resin in place of the methyl silicone resin.

### Example 8

A carrier coated with a resin was obtained in the same manner as in Example 1 except that a fluorine polyamideimide resin was used as the coating resin in place of the methyl silicone resin.

### Example 9

A carrier coated with a resin was obtained in the same manner as in Example 1 except that 0.2 wt % of a lithium salt (CF₃SO₂)₂NLi was added relative to the solid content of the coating resin.

### Example 10

A carrier coated with a resin was obtained in the same manner as in Example 1 except that 35.0 wt % of a lithium salt (CF₃SO₂)₂NLi was added relative to the solid content of the coating resin.

### Comparative Example 1

A carrier coated with a resin was obtained in the same manner as in Example 1 except that CH₁₂H₁₆F₆N₂O₄S₂ was used as a conductive material in place of a lithium salt.

### Comparative Example 2

A carrier coated with a resin was obtained in the same manner as in Example 1 except that C₁₁H₁₆F₃NO₃S was used as a conductive material in place of a lithium salt.

### Comparative Example 3

A carrier coated with a resin was obtained in the same manner as in Example 1 except that carbon black was used as a conductive material in place of a lithium salt.

### Comparative Example 4

A carrier coated with a resin was obtained in the same manner as in Example 1 except that ZnO₂ was used as a conductive material in place of a lithium salt.

The coating resins (type, coating amount) and conductive materials (type and content) used in Examples 1 to 10 and Comparative Examples 1 to 4 are shown in Table 1. Furthermore, the carriers coated with a resin obtained in Examples 1 to 10 and Comparative Examples 1 to 4 were checked for electric resistivity, color staining, charge amount (at initial, after 50K duration test (toner life test), durability) and image evaluation. The results are shown in Table 2. Note that measurement of the electric resistivity, color staining, charge amount (at initial, after 50K duration test (toner life test), durability) and image evaluation were performed by the following method.

### (Electric Resistivity)

Electric resistivity was measured as follows. Nonmagnetic parallel flat-plate electrodes (10 mm×40 mm) were placed such that the electrodes face each other at an interval of 1.0 m. A sample (a carrier coated with a resin, 200 mg) was weighed and placed in the space between the electrodes. A magnet (surface magnetic flux density: 1500 Gauss, contact area to the electrode: 10 mm×30 mm) was attached to the parallel flat-plate electrodes, thereby holding the sample between the electrodes. A voltage (100 V) was applied to measure resistivity at the applied voltage by an insulation resistivity meter (SM-8210, manufactured by DKK-TOA Corporation). Note that measurement was performed at a constant-temperature and humidity room controlled at room temperature (25° C.) and a humidity of 55%.

### (Color Staining)

Each of the carriers coated with a resin and commercially available yellow toner of DocuPrint C3530 (manufactured by Fuji Xerox Co., Ltd.) were weighed so as to obtain a developer (1 kg) having a toner concentration of 8 wt %. Thereafter, they were mixed with stirring for 30 minutes to obtain a developer.

The developer is loaded in a commercially available digital full color printer and an image chart having a 30.0% image area were printed up to 50K. The resultant chart was compared to a sample chart previously prepared to evaluate color staining. The case where no color staining was observed was evaluated as (◯), the case where staining is not outstanding as (Δ), and the case where color staining is outstanding as (X).

### (Charge Amount)

The charge amount was obtained by measuring a mixture of a carrier and a toner by a suction-type charge amount measurement apparatus (Epping q/m-meter, manufactured by PES-Laboratoriumu). The stainless-steel net used herein had 795 meshes. Toner was suctioned at a suction force of 100 MPa for 90 seconds. The charge amount after 90 seconds was calculated based on the amount of toner suctioned.

### (1) Initial Charge Amount

A developer was prepared in the same manner as used in the color staining test above. The charge amount of the developer at this time was defined as an initial charge amount.

(2) Charge Amount after 50K Duration Test (Toner Life Test)

The developer prepared above was loaded in DocuPrint C3530 (manufactured by Fuji Xerox Co., Ltd.) and a toner life test (50 k sheets) was performed. After the toner life test, charge amount was measured and defined as a charge amount after 50K duration (toner life) test.

### (3) Durability

Durability was obtained based on the following expression.

Durability (%)=(charge amount after 50K duration (toner life) test/initial charge amount)×100

### (Image Evaluation)

Furthermore, images were totally evaluated based on the presence or absence of toner scattering, good or bad of image density and presence or absence of edge effect and in accordance with the following criteria.

⊚: very good and in a practical level.
◯: Good and in a practical level.
Δ: almost good and in a practical level.
X: not good and not in a practical level.

TABLE 1

| | Coating resin | | Conductive material | |
|---|---|---|---|---|
| | | Coating amount | | Content |
| | Type | (% by weight) | Type | (% by weight) |
| Example 1 | Methyl silicone resin | 1.0 | (CF₃SO₂)₂NLi | 10.0 |
| Example 2 | Methyl silicone resin | 1.0 | CF₃SO₃Li | 10.0 |
| Example 3 | Methyl silicone resin | 1.0 | LiClO₄ | 10.0 |
| Example 4 | Methyl silicone resin | 1.0 | Li[B(C₁₄H₁₀O₃)₂] | 10.0 |
| Example 5 | Methyl silicone resin | 1.0 | (CF₃SO₂)₂NLi | 0.5 |
| Example 6 | Methyl silicone resin | 1.0 | (CF₃SO₂)₂NLi | 30.0 |
| Example 7 | Acrylic resin | 1.0 | (CF₃SO₂)₂NLi | 10.0 |
| Example 8 | Fluorine | 1.0 | (CF₃SO₂)₂NLi | 10.0 |
| | polyamideimide resin | | | |
| Example 9 | Methyl silicone resin | 1.0 | (CF₃SO₂)₂NLi | 0.2 |
| Example 10 | Methyl silicone resin | 1.0 | (CF₃SO₂)₂NLi | 35.0 |
| Comparative | Methyl silicone resin | 1.0 | CH₁₂H₁₆F₆N₂O₄S₂ | 10.0 |
| Example 1 | | | | |
| Comparative | Methyl silicone resin | 1.0 | C₁₁H₁₆F₃NO₃S | 10.0 |
| Example 2 | | | | |
| Comparative | Methyl silicone resin | 1.0 | Carbon black | 10.0 |
| Example 3 | | | | |
| Comparative | Methyl silicone resin | 1.0 | ZnO₂ | 10.0 |
| Example 4 | | | | |

TABLE 2

| | | | Charge amount (μC/g) | | | |
|---|---|---|---|---|---|---|
| | Electric | Color | | 50K | | Image |
| | resistivity | stain- | | duration | | evalu- |
| | (Ω · cm) | ing | Initial | test | Durability | ation |
| Example 1 | 3.50 × 10⁹ | ◯ | 24.3 | 21.9 | 90.2 | ⊚ |
| Example 2 | 2.40 × 10⁷ | ◯ | 24.0 | 21.3 | 88.6 | ⊚ |
| Example 3 | 7.00 × 10¹⁰ | ◯ | 22.1 | 20.5 | 93.1 | ◯ |
| Example 4 | 6.50 × 10¹⁰ | ◯ | 23.0 | 21.3 | 92.7 | ◯ |
| Example 5 | 3.50 × 10¹¹ | ◯ | 35.7 | 33.7 | 94.5 | ◯ |
| Example 6 | 2.20 × 10⁷ | ◯ | 19.9 | 17.0 | 85.3 | ◯ |
| Example 7 | 7.10 × 10⁸ | ◯ | 34.6 | 30.4 | 87.9 | ⊚ |
| Example 8 | 2.10 × 10⁹ | ◯ | 15.4 | 14.3 | 93.1 | ◯ |
| Example 9 | 9.80 × 10¹¹ | ◯ | 32.4 | 30.3 | 93.7 | Δ |
| Example 10 | 5.50 × 10⁶ | ◯ | 18.9 | 15.7 | 83.2 | Δ |
| Comparative | 2.80 × 10¹² | ◯ | 13.1 | 10.3 | 79.1 | X |
| Example 1 | | | | | | |
| Comparative | 4.10 × 10¹² | ◯ | 22.1 | 17.0 | 76.9 | X |
| Example 2 | | | | | | |
| Comparative | 9.30 × 10⁷ | X | 35.7 | 29.2 | 81.7 | ◯ |
| Example 3 | | | | | | |
| Comparative | 1.90 × 10¹² | Δ | 25.5 | 22.0 | 86.4 | X |
| Example 4 | | | | | | |

As is apparent from the results of Table 2, each of the carriers of Examples 1 to 10 has an electric resistivity within a satisfactory level and is free of color staining. In addition, charge amount does not decrease with the passage of time and image evaluation is almost good.

In contrast, each of the carriers of Comparative Examples 1, 2 and 4 has a high electric resistivity. In Comparative Examples 1 and 2, the charge amount significantly decreases with the passage of time. Comparative Example 3 shows significant color staining. Furthermore, in Comparative Examples 1, 2 and 4, image evaluation is poor.

A carrier for an electrophotographic developer according to the present invention and an electrophotographic developer using the carrier show no significant color staining even if used with a toner, particularly, a color toner, free of image quality deterioration, more specifically, an image-density decrease and edge effect caused when the resistivity of the carrier increases. In addition, the carrier and developer are less dependent on an environment and has excellent durability causing no charge-amount decrease with the passage of time.

Accordingly, a carrier coated with a resin for an electrophotographic developer according to the present invention and an electrophotographic developer using the carrier can be widely used in machines including a full-color machine requiring a high image quality and a high-speed machine requiring image-maintenance reliability and durability.

1. A carrier coated with a resin for an electrophotographic developer, wherein a carrier particle surface is coated with the resin and the coating resin contains a lithium salt.

2. The carrier coated with a resin for an electrophotographic developer according to claim 1, wherein the lithium salt is an ionic conductive polymer and an addition amount of the lithium salt relative to a solid content of the coating resin is 0.2 to 35.0 wt %.

3. The carrier coated with a resin for an electrophotographic developer according to claim 1, wherein the lithium salt has a fluorine group.

4. An electrophotographic developer comprising the carrier coated with a resin according to claim 1 and a toner.

5. The electrophotographic developer according to claim 4, being used as a replenishing developer.

6. The carrier coated with a resin for an electrophotographic developer according to claim 2, wherein the lithium salt has a fluorine group.

7. An electrophotographic developer comprising the carrier coated with a resin according to claim 2 and a toner.

8. An electrophotographic developer comprising the carrier coated with a resin according to claim 3 and a toner.

9. An electrophotographic developer comprising the carrier coated with a resin according to claim 6 and a toner.

10. The electrophotographic developer according to claim 7, being used as a replenishing developer.

11. The electrophotographic developer according to claim 8, being used as a replenishing developer.

12. The electrophotographic developer according to claim 9, being used as a replenishing developer.
